(19) United States
(12) Patent Application Publication
(10) Pub. No.: US 2005/0279519 A1
(43) Pub. Date: Dec. 22, 2005

(54) Right angle impact driver

(75) Inventor: Weldon H. Clark, Liberty, SC (US)

Correspondence Address: BRINKS HOFER GILSON & LIONE, P.O. BOX 10395, CHICAGO, IL, 60610, US

(73) Assignee: One World Technologies Limited

(21) Appl. No.: 10/870,815

(22) Filed: Jun. 17, 2004

(51) Int. Cl. B25D 13/00

(52) U.S. Cl. 173/216

(57) ABSTRACT

A hand held power tool has a housing, a motor, a power source, a cam shaft, a hammer, an integrated anvil-gear, a second gear, and an output. The motor is disposed in the housing and has a motor axis. The power source energizes the motor. The cam shaft is driven by the motor and the hammer is driven by the cam shaft. The integrated anvil-gear has an anvil end and a first gear end, and the anvil end is impacted by the hammer. The second gear engages the first gear end and defines an output axis that is at a predefined angle with respect to the motor axis. An output is coupled to the second gear.

### RELATED APPLICATIONS

The present invention relates to impact drivers, and more particularly to a right angle rotary impact driver with an integrated anvil and gear.

### BACKGROUND

Rotary impact power tools are used to tighten or loosen fastening devices such as bolts, nuts, screws, etc. Rotary impact power tools generally use a pneumatic or electric motor that drives a hammer to rotationally impact an anvil, which in turn is coupled with an output such as a drive socket. Right angle impact drivers have been developed that place bevel gears between the anvil and output shaft so that the output shaft is perpendicular to the motor drive shaft. This right angle output allows the impact driver to be used in cramped or tight locations. One commercially available right angle impact driver is the Model 6940D Cordless Right Angle Impact Driver from MAKITA U.S.A., Inc. of La Mirada, Calif., United States of America. This and other prior art right angle impact drivers use many parts to transition from the anvil to the bevel gear, using a separate anvil assembly coupled with a separate bevel gear assembly. In the MAKITA Model 6940D, for example, the anvil assembly includes the anvil, two washers, a spacer sleeve, and a retaining ring. The bevel gear assembly includes the bevel gear, two ball bearings, a spacer sleeve, and a retaining ring. The anvil is connected to the bevel gear through a splined coupling. This coupling requires precise axial alignment, presents a potential failure point as the coupling wears, and decreases the impact energy transmitted from the hammer to the output. Further, given the large number of parts required to couple the anvil and bevel gear, manufacturing costs are increased.

For the foregoing reasons, there is a need for a right angle impact driver with a coupling between the anvil and bevel gear that reduces the part count and avoids the alignment, energy loss, and failure concerns associated with existing designs.

### BRIEF SUMMARY

Accordingly, embodiments of the present invention provide a new and improved right angle impact driver. In one embodiment, the coupling between an anvil and a bevel gear is replaced by integrally forming an integrated anvil-gear. This reduces the number of parts needed in a right angle impact driver, eliminates a potential failure point in the coupling between the anvil and bevel gear, provides for a more direct transfer of drive torque to the output, reduces impact energy loss, and eases assembly and alignment.

According to a first aspect of the invention, an angle impact driver may include a hammer and an integrated anvil-gear. The integrated anvil-gear has an anvil and a gear, with the hammer impacting the anvil.

According to a second aspect of the invention, a hand held power tool may include a housing, a motor, a power source, a cam shaft, a hammer, an integrated anvil-gear, a second gear, and an output. The motor is disposed in the housing and has a motor axis. The power source energizes the motor. The cam shaft is driven by the motor and the hammer is driven by the cam shaft. The integrated anvil-gear has an anvil end and a first gear end, with the anvil end impacted by the hammer. The second gear engages the first gear end and defines an output axis that is at a predefined angle with respect to the motor axis. An output is coupled to the second gear.

A third aspect of the invention is an angle impact driver and may include a housing, a motor, a power source, a transmission, a cam shaft, a hammer, an integrated anvil-gear, a second gear, and an output. The motor is disposed in the housing and has a motor axis. The power source energizes the motor. The transmission is driven by the motor. The cam shaft is coupled with the transmission. The hammer is axially aligned with the cam shaft and is driven rotationally and axially by the cam shaft. The integrated anvil-gear has an anvil end and a first gear end, and is rotationally impacted by the hammer. The second gear engages the first gear end and defines an output axis that is at a predefined angle with respect to the motor axis. An output is coupled to the second gear.

A fourth aspect of the invention is a power tool for tightening and loosening fasteners and may include a motor, a transmission, a hammer, an integrated anvil-gear, a second gear, and an output. The motor defines a motor axis. The transmission is driven by the motor. The hammer is coupled with the transmission. The integrated anvil-gear has an anvil at a first end and a first gear at a second end. The anvil is impacted by the hammer. The second gear engages the first gear and defines an output axis at a predefined angle with respect to the motor axis. The output is coupled with the second gear.

### BRIEF DESCRIPTION OF THE DRAWINGS

FIG. 1 shows an exploded view of the exemplary right angle impact driver that incorporates the integrated anvil and gear of the present invention, with the housing shown removed.

FIG. 2 shows a side view of an exemplary right angle impact driver that incorporates the integrated anvil and gear of the present invention, with the housing shown removed.

FIG. 3 shows a cross section view of an exemplary right angle impact driver that incorporates the integrated anvil and gear of the present invention taken along the lines 3-3 in FIG. 2.

FIG. 4 is a side view of the integrated anvil and gear of the present invention.

FIG. 5 is an end view of the integrated anvil and gear of the present invention, showing the gear.

FIG. 6 is an end view of the integrated anvil and gear of the present invention, showing the anvil.

FIG. 7 is a side view of the integrated gear and output shaft of the present invention.

FIG. 8 is an end view of the integrated gear and output shaft of the present invention, showing the gear.

FIG. 9 is an end view of the integrated gear and output shaft of the present invention, showing the output shaft.

### DETAILED DESCRIPTION OF THE DRAWINGS AND THE PRESENTLY PREFERRED EMBODIMENTS

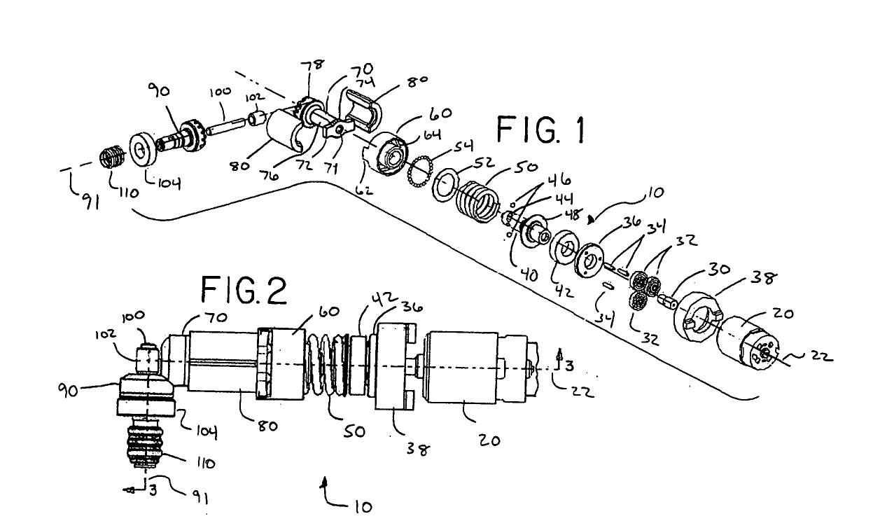

Referring now to FIG. 1, a right angle impact driver 10 is shown with a plastic clam shell housing (not shown) removed. The right angle impact driver 10 includes a motor 20. The motor 20 is preferably an electric motor and is energized by a power source such as a rechargeable battery (not shown) or an AC line current. Alternately, the motor 20 can be a pneumatic motor, powered by a pressurized air line. The motor 20 has a shaft (not shown) with a motor axis 22.

The motor shaft is attached to a transmission. The transmission includes a sun gear 30 attached to the motor shaft, a plurality of planet gears 32, a carrier 36, and a planet ring gear 38. The sun gear 30 engages the plurality of planet gears 32, which are each rotatably mounted on a planet gear pin 34 on the carrier 36. The planet ring gear 38 is fixed in the housing and has internal teeth that mesh with the planet gears 32. As the motor 20 rotates sun gear 30, the sun gear 30 rotates the planet gears 32. The planet gears 32 are constrained to rotate about the motor axis 22, running around the planet ring gear 38. As a result, a speed reduction is achieved with carrier 36 rotating about the motor axis 22 at a speed less than the rotation of the sun gear 30 and motor shaft. Alternately, the transmission can be any kind of transmission.

The carrier 36 is rotatably coupled with a camming arrangement. The camming arrangement consists of a cam shaft 40, two camming balls 46 located in integrally formed camming grooves 44 on the cam shaft 40, and an impact spring 50. A first roller bearing 42 journals the cam shaft 40, providing rotational support. The end opposite the carrier 36 of the cam shaft 40 is seated into an axial recess 71 of an integrated anvil-gear 70, providing axial support and alignment with the integrated anvil-gear 70. The impact spring 50 is preferably a coil spring, with one end supported by an integrally formed radially extending flange 48 of cam shaft 40, while the other end axially biases a rotary hammer 60.

The hammer 60 rotates about cam shaft 40 and is axially slidable relative to cam shaft 40 due to impact spring 50. The camming arrangement forces the hammer 60 axially against the resistance of impact spring 50 during each revolution of the hammer 60 so as to bring the radial sides of a pair of hammer lugs 62 that project axially from a forward wall of the hammer 60 into rotary impact with the radial sides of a pair of lugs 72 that project from the integrated anvil-gear 70.

The hammer 60 also has an axial channel 64 where a plurality of impact balls 54 is located. The axial channel 64 is preferably sized so that eighteen stainless steel impact balls 54 of 3.50 mm diameter can be positioned within it, although it may be sized so that other sizes or numbers of impact balls 54 may be used. An impact washer 52 is positioned on the impact balls 54 in the axial channel 64. Axial or rotational loads on the impact spring 50 are taken up the roller bearing formed by impact washer 52 and impact balls 54.

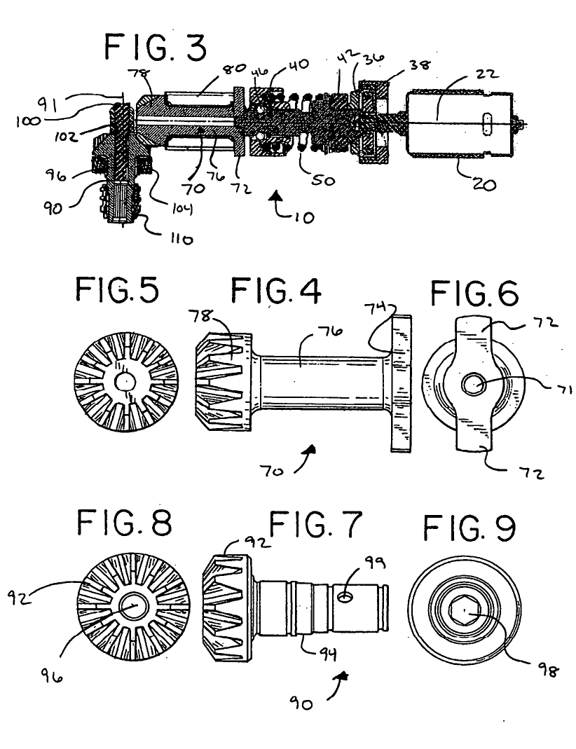

As shown in FIGS. 4-6, the integrated anvil-gear 70 is a one-piece design consisting of an anvil portion 74 with radially projecting lugs 72, a shaft 76, and a bevel gear 78. The integrated anvil-gear 70 is integrally formed, preferably machined from Grade SNCM 220. Steel bar stock, with an oil dip finish to prevent rust. The teeth of bevel gear 78 may be ground as a Zerol bevel gear, although straight, spiral or hypoid bevel gear designs may also be used. As shown in FIGS. 1-3, the integrated anvil-gear 70 is supported for rotation by means of two halves of a split sleeve bearing 80. Split sleeve bearing 80 is placed over shaft 76. Split sleeve bearing 80 is preferably made from sintered copper and iron with a Metal Powder Industries Federation (MPIF) designation of FC-2008 and a K Factor (indicating radial crushing strength) of K46, although other formulations or different types of bearings may be used. The split sleeve bearing 80 is also preferably vacuum impregnated with a lubricant such as MOBIL SHC 626 at 17% by volume, although other lubricants and impregnation volumes may be used. Split sleeve bearing 80 and integrated anvil-gear 70 are housed in a casting with a pin (not shown) installed to prevent rotation within the casting. The casting is clamped to the plastic clamshell housing, with alignment ribs in the housing that mate with the casting.

Gear teeth from bevel gear 78 engage gear teeth from an integrated gear-output 90. The teeth of integrated gear-output 90 may be ground as a Zerol bevel gear, although straight, spiral or hypoid bevel gear designs may also be used. As shown in FIGS. 2 and 3, integrated gear-output 90 defines an output axis 91 and is preferably aligned perpendicular to bevel gear 78 and motor axis 22, although it may be aligned at some other angle. As shown in FIGS. 7-9, integrated gear-output 90 is a one-piece design consisting of a bevel gear portion 92 with a shaft portion 94. As shown in FIG. 3, a cylindrical bore 96 extends axially through the bevel gear portion 92. A pin 100 is press fit into bore 96, with an exposed portion of the pin 100 rotationally supported by a bushing 102. Bushing 102 may be formed similarly to split sleeve bearing 80, described above.

A second roller bearing 104 is positioned on shaft 94 and provides rotational support for the integrated gear-output 90. Both first roller bearing 42 and second roller bearing 104 may be obtained from NTN BEARING CORPORATION OF AMERICA, preferably part number 6002, although other bearings and bearing suppliers may be used. A retaining ring (not shown) in a radial groove (not shown) on shaft 94 may be used to axially secure second roller bearing 104 to shaft 94.

As seen in FIG. 9, a hexagonal bore 98 extends axially through the shaft portion 94. Hexagonal bore 98 is preferably sized to accommodate an output with a standard ¼ inch hexagonal shank, but may be sized with other dimensions. Such outputs may include a screwdriver bit, a drive socket, an adapter, etc. A transverse bore 99 extends radially into hexagonal bore 98 on shaft 94 to house a spring loaded detent ball (not shown). The spring loaded detent ball engages a radial groove (not shown) in standard ¼ inch hexagonal shanks, providing an axial lock. As shown in FIGS. 1-3, a barrel 110 is positioned over the shaft 94 and provides a lock for the spring loaded detent ball. Barrel 110 may be axially secured to the shaft 94 through a retaining ring (not shown) in a radial groove (not shown) on shaft 94. Barrel 110 may also be spring-loaded with a spring (not shown) biasing the barrel.

In operation, as the motor 20 rotates, drive is transmitted through the transmission to the cam shaft 40. The camming arrangement disposed about the cam shaft 40 rotationally and axially displaces hammer 60 along cam shaft 40 to rotationally impact integrated anvil-gear 70. Integrated anvil-gear 70, in turn, directly transmits the drive ninety (90°) degrees through its bevel gear to integrated gear-output 90 and ultimately to an output.

The present invention is applicable to angle impact drivers and provides an integrated anvil-gear that eliminates the need for a coupling between an anvil and a bevel gear. The integrated anvil-gear reduces the number of parts needed in a right angle impact driver, eliminates a potential failure point in the coupling between the anvil and bevel gear, provides for a more direct transfer of drive torque to the output, reduces impact energy loss, and eases assembly and alignment.

It is therefore intended that the foregoing detailed description be regarded as illustrative rather than limiting, and that it be understood that it is the following claims, including all equivalents, that are intended to define the spirit and scope of this invention.

1. An angle impact driver comprising:
a. a hammer; and
b. an integrated anvil-gear having an anvil and a gear, wherein the hammer impacts the anvil.

2. A hand held power tool comprising:
a. a housing;
b. a motor disposed in the housing defining a motor axis;
c. a power source that energizes the motor;
d. a cam shaft driven by the motor;
e. a hammer driven by the cam shaft;
f. an integrated anvil-gear having an anvil end and a first gear end, with the anvil end impacted by the hammer;
g. a second gear engaging the first gear end, wherein the second gear defines an output axis at a predefined angle with respect to the motor axis; and
h. an output coupled with the second gear.

3. The hand held power tool of claim 2, wherein the motor is an electric motor or a pneumatic motor and wherein the power source is a battery, AC line current, or pneumatic pressure.

4. The hand held power tool of claim 2, wherein the first gear end and the second gear are bevel gears.

5. The hand held power tool of claim 4, wherein the first gear end and the second gear are Zerol bevel gears.

6. The hand held power tool of claim 2, wherein the integrated anvil-gear is rotationally supported by a split bearing with two halves.

7. The hand held power tool of claim 2, wherein the second gear is integral with an output shaft.

8. The hand held power tool of claim 2, wherein the predefined angle is approximately ninety degrees.

9. An angle impact driver comprising:
a. a housing;
b. a motor disposed in the housing defining a motor axis;
c. a power source that energizes the motor;
d. a transmission driven by the motor;
e. a cam shaft coupled with the transmission;
f. a hammer axially aligned with the cam shaft, wherein the hammer is driven rotationally and axially by the cam shaft;
g. an integrated anvil-gear rotationally impacted by the hammer and having an anvil end and a first gear end;
h. a second gear engaging the first gear end, wherein the second gear defines an output axis at a predefined angle with respect to the motor axis; and
i. an output coupled with the second gear.

10. The angle impact driver of claim 9, wherein the motor is an electric motor or a pneumatic motor and wherein the power source is a battery, AC line current, or pneumatic pressure.

11. The angle impact driver of claim 9, wherein the transmission further comprises:
a. a sun gear driven by the motor; and
b. a plurality of planet gears driven by the sun gear, wherein the plurality of planet gears engage a ring gear and are rotatably mounted to a carrier, and wherein the cam shaft is coupled with the carrier for rotation with the carrier.

12. The angle impact driver of claim 9, wherein the first gear end and the second gear are bevel gears.

13. The angle impact driver of claim 12, wherein the first gear end and the second gear are Zerol bevel gears.

14. The angle impact driver of claim 9, wherein the integrated anvil-gear is rotationally supported by a split bearing with two halves.

15. The angle impact driver of claim 9, wherein the second gear is integral with an output shaft.

16. The angle impact driver of claim 9, wherein the predefined angle is substantially ninety degrees.

17. A power tool for tightening and loosening fasteners comprising:
a. a motor defining a motor axis;
b. a transmission driven by the motor;
c. a hammer coupled with the transmission;
d. an integrated anvil-gear having an anvil at a first end and a first gear at a second end, with the anvil impacted by the hammer;
e. a second gear engaging the first gear, wherein the second gear defines an output axis at a predefined angle with respect to the motor axis; and
f. an output coupled with the second gear.

18. The power tool of claim 17, wherein the first and second gears are Zerol bevel gears.

19. The power tool of claim 17, wherein the integrated anvil-gear is rotationally supported by a split bearing with two halves.

20. The power tool of claim 17, wherein the second gear is integral with an output shaft.
